(19) United States
(12) Patent Application Publication
(10) Pub. No.: US 2015/0007278 A1
(43) Pub. Date: Jan. 1, 2015

(54) AUTHENTICATION FOR SINGLE PAGE WEB INTERFACES

(71) Applicant: Business Objects Software Ltd., Dublin (IE)

(72) Inventor: Steve Benezra, Walldorf (DE)

(21) Appl. No.: 13/930,895

(22) Filed: Jun. 28, 2013

(51) Int. Cl. H04L 29/06

(52) U.S. Cl. CPC H04L 63/08
USPC 726/5

(57) ABSTRACT

A single application page may include a main view, a login view, and an error view as part of the same page. The login view and the error view may each be associated with a parameter. A client device may request the single application page from a web server. If the client device is not previously authenticated, the single application page switches to the login view. The web server receives login credentials to be authenticated. If the login credentials are valid, the web server may indicate the successful authentication to the client device. The single application page switches to a main view in response to the successful authentication. If the login credentials are invalid, an error parameter may be sent to the client device indicative of the unsuccessful authentication. The single application page may switch to the error view or login view in response to the unsuccessful authentication.

### BACKGROUND

Conventional web applications may utilize form-based user authentication mechanisms to authenticate a client device prior to permitting access to subsequent secured application pages. When a client device requests access to the secured application pages, a determination is made by a web server hosting the web application whether the client device is authenticated. If the client device is not authenticated, the web server redirects the client device to a separate login page. A user of the client device enters the required credentials into a form on the page and the form is posted back to the web server to a form-based authentication mechanism. If the authentication is successful, the client device is redirected to the main secured application page as an authenticated client device. If the authentication is unsuccessful, the client device is redirected to an error page or other page, such as the login page. The applicant has found that this conventional login system may not work well with a single page web interface, such as an Ajax-based web site. For example, the conventional system can result in redundant page calls and loads that reduce the overall performance. It is challenging and difficult to design efficient login mechanisms for single page web interfaces.

### SUMMARY

One implementation relates to a method for authenticating login credentials for a single application page. The method may include requesting a single application page from a web server using a client device. The single application page may include a main view, a login view, and an error view as part of the same single application page. The single application page may be received from the web server at the client device. The single application page may be loaded in the login view at the client device. Login credentials may be transmitted to the web server using the client device. The single application page may be loaded in the main view if the web server indicates that the login credentials are valid.

Another implementation relates to a system that includes a processing module and a non-transitory computer-readable storage device storing instructions that, when executed by the processing module, cause the processing module to perform several operations. The operations may include transmitting a JavaServer Page in response to a request from a client device. The operations may further include receiving login credentials from the client device. The operations may also include determining if the login credentials are valid. The operations may include transmitting a URL for the JavaServer Page to the client device in response to the determination. The JavaServer Page is operable to switch to a login view if the client device is not previously authenticated, an error view if the URL for the JavaServer Page is transmitted with a parameter indicating that the login credentials are invalid, and a main view if the client device is previously authenticated or the URL for the JavaServer Page is transmitted without any parameters. The login view, error view, and main view are part of the same JavaServer Page.

Yet another implementation relates to a non-transitory computer-readable storage device storing instructions that, when executed by a processing module, cause the processing module to perform several operations. The operations may include transmitting a JavaServer Page in response to a request from a client device, receiving login credentials from the client device, and transmitting a URL for the JavaServer Page to the client device in response to the determination. The JavaServer Page may be operable to switch between a login view and a main view. The login view and the main view may be part of the same JavaServer Page. The JavaServer Page may be further operable to operable to transmit the login credentials using an Ajax call.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a flow diagram of an example method for authenticating login credentials for a single application page;

FIG. 2 is an overview of an example web browser showing an example single application page;

FIG. 3 is an overview of the example web browser of FIG. 2 showing the example single application page depicting a login view;

FIG. 4 is an overview of the example web browser of FIG. 2 showing the example single application page depicting an error view;

FIG. 5 is an overview of the example web browser of FIG. 2 showing the example single application page depicting a main view with content;

FIG. 6 is a flow diagram of an example process for authenticating a client device and switching views for the single application page of FIG. 2;

FIG. 7 is a sequence diagram of the example process of FIG. 6;

FIG. 8 is a block diagram illustrating a general architecture for a computer system that may be employed to implement various elements of the systems and methods described and illustrated herein;

FIG. 9 is a block diagram illustrating a general architecture for a web server that may be employed to implement various elements of the systems and methods described and illustrated herein; and

FIG. 10 is a flow diagram of an example method for configuring an existing post-based application page to a single application page with a login view and an error view.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

A computing device (e.g., a client device) can view a resource, such as a web application, via the Internet by communicating with a server, such as a web server, corresponding to that resource. In some implementations, when a client device requests a web application from the web server, the web server may respond with a single application page that will be utilized for the entire duration of the session with the client device. Accordingly, the single application page may include common application resources and framework libraries that only need to be sent once to the client device. In one example implementation, the single application page may use Asynchronous JavaScript® and XML (Ajax) to exchange data with the web server to update portions of the single application page without reloading the entire page. Such a single application page and selective data exchanges with the web server may reduce the amount of data to be transferred between the web server and the client device since the page does not need to be reloaded in its entirety during user navigation because the common application resources and framework libraries may be loaded only once. In addition, such a single application page and selective data exchanges may reduce the traffic and processing by the web server, thereby potentially increasing the capacity for the server to respond to other client device requests.

In the instances where a developer would prefer to secure the web application, a form of authentication for the client device may need to be implemented. For conventional form-based authentication mechanisms, a separate login page may be created. Thus, when a client device requests access to the main secured application page, a determination is made by the web server hosting the web application if the client device is authenticated. If the client device is not authenticated, a web server using the conventional method redirects the client device to the separate login page. When the login page initially loads using the conventional method, data may be transmitted to the client device from the web server to load the web resources and framework libraries to present the login page on the client device. A user of the client device may then enter the required credentials into a form on the page and the page and form are posted back to the web server to a form-based authentication mechanism using the conventional method. If the authentication is unsuccessful, the client device is redirected to an error page or other page, such as the login page, under the conventional method. If the authentication is successful, the client device is redirected to the main secured application page as an authenticated client device. In both instances, the web resources and framework libraries may be retransmitted to the client device from the web server. Thus, the extraneously transmitted data using conventional methods may degrade performance, both on the client device and the web server. In addition, the separate login page and the main secured application page reduce the efficacy of utilizing a single application page.

Accordingly, it may be useful to provide a single application page that can utilize a form-based authentication mechanism without needing a separate login page, thereby not needing to reload the webpage. Such a single application page that does not need to be reloaded may advantageously reduce the data transmitted between the web server and the client device. In addition, such a single application page may permit existing web applications that utilize a page postback request-response model and a form-based authentication mechanism to be adapted to a single application page model while still using the existing robust form-based authentication mechanism.

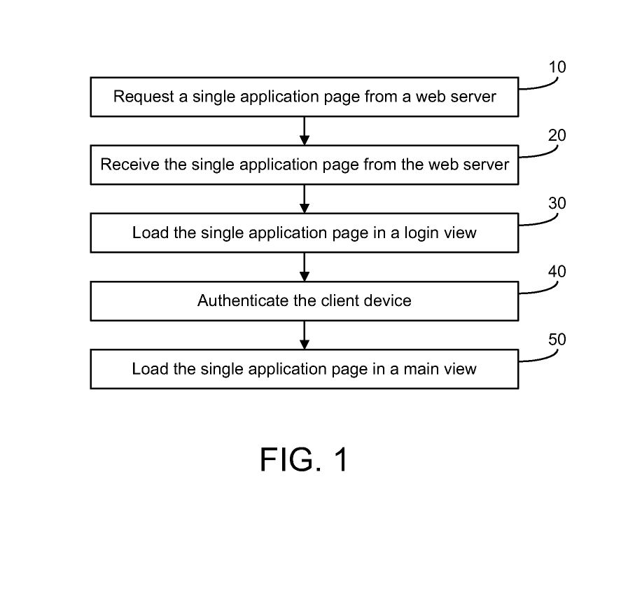

FIG. 1 depicts an example flow diagram of an overview method for authenticating a client device for a single page application. The method may include requesting a single application page from a web server (block 10). For example, a user of a client device may enter an address for a uniform resource locator (URL) for the single application page into a web browser executed on the client device. Based on the URL, the client device may send a request to the web server via a communications module for the data to display the single application page on a display of the client device. The web server may retrieve the data for the single application page and may transmit the data to the client device in response to the request. The client device may receive the data for the single application page from the web server (block 20). As will be discussed in greater detail below, the data for the single application page may include a login view component, an error view component, a secured main view component, a non-secured main view component, common resources for the several views, etc.

After receiving the data for the single application page (block 20), the data for the single application page may cause the client device to determine if the client device is authenticated, such as by determining if a cookie stored in a computer-readable medium of the client device indicates that the client device has been previously authenticated. If the client device is authenticated, then the data for the single application page may cause the client device to switch to a secured main view without reloading the application page. The switching to the secured main view may include requesting additional data from the web server (e.g., images, text, etc.) to render the single application page in the secured main view, as discussed in greater detail below. If the client device is not authenticated, the data for the single application page may cause the client device to switch to a login view (block 30) without reloading the application page. The switch to the login view may simply include unhiding the login view and hiding the other views (e.g., the main view and an error view). In the present example, the switch to the login view does not request additional data from the web server and the application page is not reloaded. Thus, no additional requests may need to be sent to the web server, thereby reducing the network traffic and processing for the web server. In some implementations, only some data may be requested when switching to the login view (e.g., images and/or text), but the application page is still not reloaded. For example, if an image is used with the login view only, such an image may be requested from the web server once the single application page has switched to the login view. However, it should be understood that, even if the login view requests additional data, the login view and secured main view are the same page and no new page needs to be loaded. In some instances, the login view, the error view, and the secured main view are part of the same page.

After the user of the client device enters his/her credentials into a login field or fields of the login view, the user may select a feature, such as a button, to cause the client device to transmit the login credentials to the web server or another computing device to authenticate the login credentials (block 40). In one example, the authentication may include an Ajax call to a j_security_check function of the web server or other computing device to authenticate the login credentials, as will be discussed in greater detail below. During this authentication, the single application page is not posted back to web server. Instead, the credentials are transmitted to the web server while the single application page remains loaded and displaying the login view while the credentials are authenticated. If the response to the Ajax call to the j_security_check function indicates that the credentials have not been authenticated (e.g., an error parameter is returned), then the data for the single application page may cause the client device to switch to the error view. In some instances, this may simply include unhiding the error view and hiding the login view. In other instances, this may include unhiding error text and/or another indicator of the login view that the login credentials were not authenticated.

If the response to the Ajax call to the j_security_check function indicates that the credentials have been authenticated (e.g., no error parameter is returned), then the data for the single application page may cause the client device to switch to and load the single application page in a secured main view (block 50). The switching to the secured main view may include hiding the login view and unhiding the secured main view. In some implementations, the switching to the secured main view may include requesting additional data from the web server (e.g., images, text, etc.) to render the single application page in the secured main view.

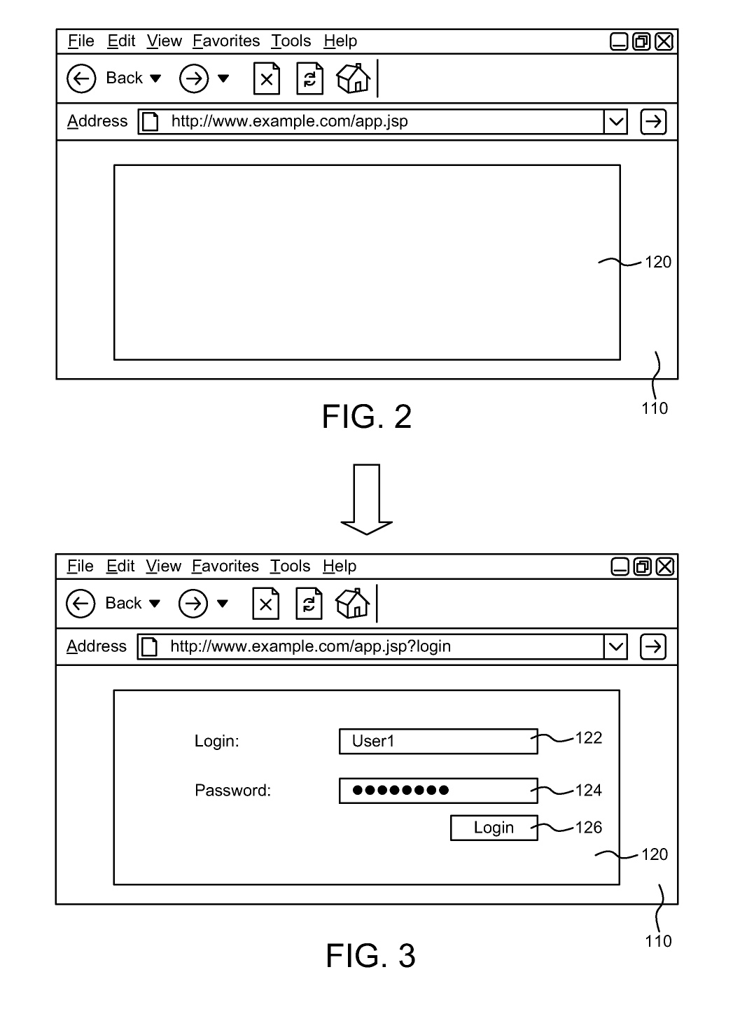

FIG. 2 depicts an example web browser 110 having a single application page 120 depicted on an example client device. The single application page 120 may include an empty container that requests resources from a web server only after a client device is authenticated, such as that depicted in FIG. 2. In some implementations, a non-secured main view may be loaded prior to the login view (e.g., the non-secured main view may be loaded and a selection feature, such as a login button, may be selected to switch to the login view). The single application page 120 may include several parameterized page views, as will be discussed in greater detail below. In the present example, the single application page 120 is a JavaServer Page (JSP), though other forms for application pages may be utilized. The single application page 120 is identified by “app.jsp,” as shown in the URL portion of the web browser 110. The single application page 120 may be configured as a secured resource. The configuration for the single application page 120 may use a form-based authentication having a login page set as the “app.jsp?login” view of the single application page 120 and the error page set as the “app.jsp?error” view of the single application page 120. The form-based authentication configuration may include the following:

```
<login-config>
    <auth-method>FORM</auth-method>
    <form-login-config>
        <form-login-page>/app.jsp?login</form-login-page>
        <form-error-page>/app.jsp?error</form-error-page>
    </form-login-config>
</login-config>
```

Thus, the form-based authentication mechanism may be configured to have the designated login view and error view of the single application page 120 be essentially the same page as the protected resource being requested, but with different URL parameters (e.g., “login” or “error”).

When an unauthenticated client device of a user requests the “app.jsp” page, data may be transmitted to the client device from the web server to load common application web resources and JavaScript® framework libraries. Because the client device is not authenticated, the client device is redirected to the login view of the single application page 120 of “app.jsp?login” based on the parameterized login view.

FIG. 3 depicts an example login view for the single application page 120 for “app.jsp?login.” The login view for the single application page 120 includes a login identification text entry box 122, a password text entry box 124, and a login button 126. When the client device is redirected to the login view for the single application page 120, the parameter “login” is used by the single application page “app.jsp” to render the page in the login view. Thus, it should be understood that the login view is part of the single application page 120 and is not a separate page. Thus, the common application web resources and JavaScript® framework libraries previously loaded when the unauthenticated client device requested the “app.jsp” page need not be loaded again. When a user enters his/her credentials into the login identification text entry box 122 and the password text entry box 124 and selects the login button 126, the single application page 120 does not postback to the web page server. That is, the state of the login button 126 control, plus any other controls (e.g., the login identification text entry box 122 control and the password text entry box 124 control) of the page, known as the View State, are not posted back to the web server. Rather, a background call may post the credentials to the server. For example, an Ajax call to the function j_security_check may be used to determine whether the credentials entered by the user into the login identification text entry box 122 and the password text entry box 124 are authenticated. One example of such an Ajax call may include:

```
jQuery.ajax({
    type: “POST”,
    url: “j_security_check”,
    data: {
        j_username: “username”,
        j_password: “password”
    },
    success: function(result) {
        //check for URL parameter and hide/unhide views as required
    },
    error: function(result) {
        //handle errors
```

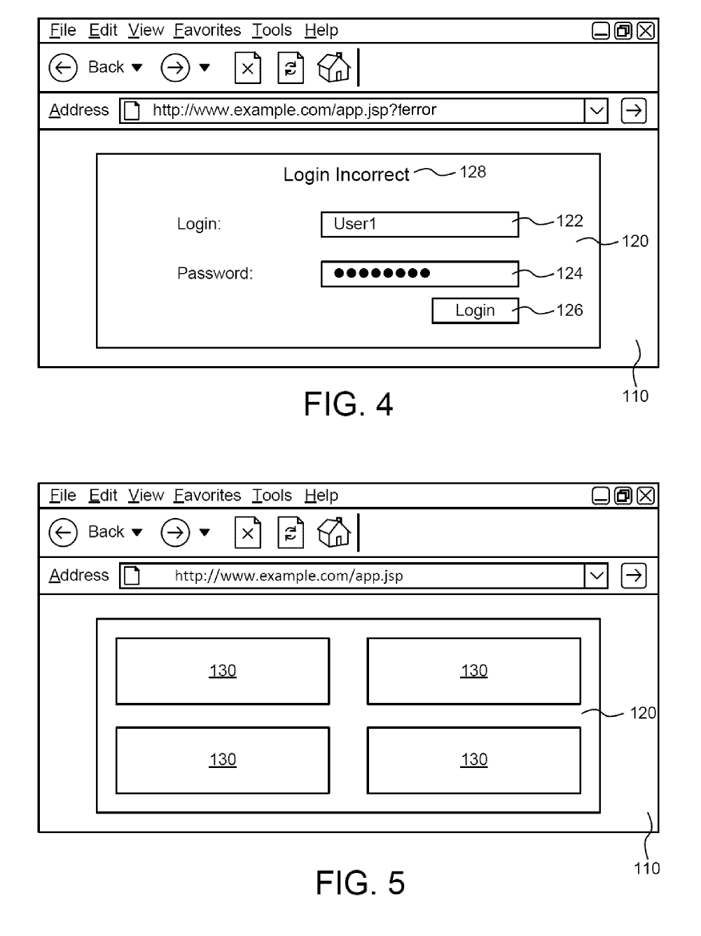

If the credentials are not authenticated, then the Ajax call to the j_security_check function will return the URL for the secured single application page 120 with an error parameter, such as “error,” which may be used by the single application page 120 “app.jsp” to render in the error view. An example error view is shown in FIG. 4 having error text 128 indicating that the user credential information was not authenticated. In the present example, the error view includes the login identification text entry box 122, the password text entry box 124, and the login button 126 such that a user of the client device may enter new credentials. When a user enters his/her credentials into the login identification text entry box 122 and the password text entry box 124 and selects the login button 126, another background call may post the credentials to the server again.

If the credentials are authenticated, then the Ajax call to the j_security_check function will return the URL for the single application page 120 “app.jsp” to be rendered in a secured main view without the error parameter or the login parameter. As shown in the foregoing example, if the result of the Ajax call is successful, then the returned URL for the single application page 120 may be checked for any other parameters to be used by the single application page 120 when rendering the secured main view. In addition, the secured main view and/or portions thereof may be unhidden and other views (e.g., the login view or error view) may be hidden. An example of a main view is shown in FIG. 5 having several content portions 130 shown. In an implementation, data for the content portions 130 may not be retrieved from the web server until the single application page 120 is returned from the web server. When the credentials are authenticated, a request for resources for content to populate the main view of the single application page 120 from the web server may be transmitted in response. In some implementations, the files for the content portions 130 may also be configured as secured resources on the web server such that the files are not loaded until after the client device is authenticated. In other implementations, the content portions 130 and/or the main view may be unhidden in response to receiving the URL for the single application page 120 without the error parameter or the login parameter after authentication.

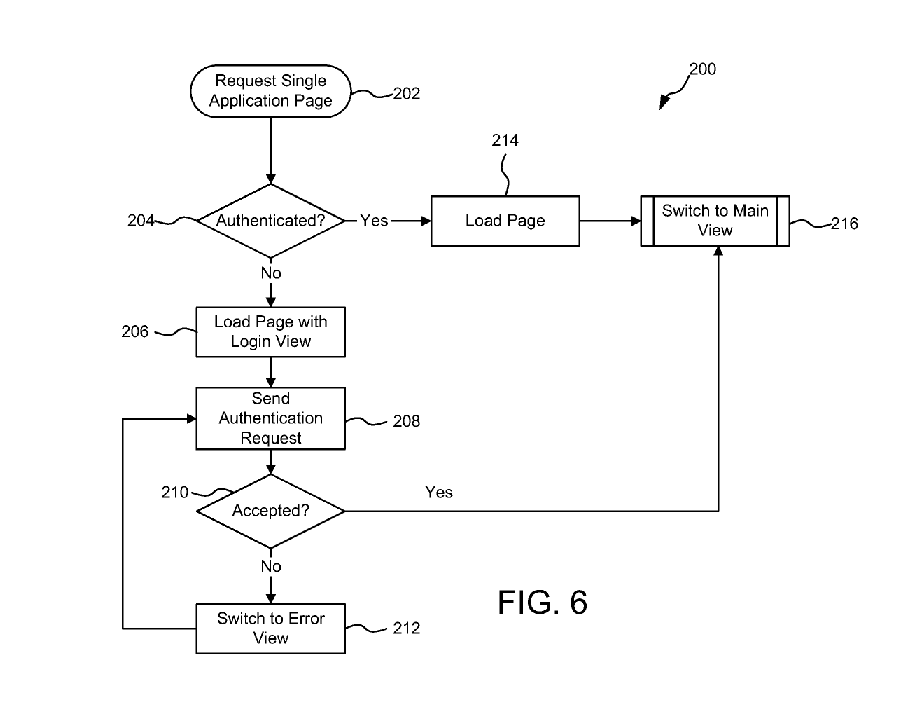

FIG. 6 depicts an example flow diagram of a process 200 for authenticating a client device for a single page application using a form-based authentication mechanism that is configured to have the designated login view and error view be essentially the same page as the protected resource being requested, but with different URL parameters. In the present example, the process 200 may begin when a client device requests a single application page (block 202), such as “app.jsp,” from a web server. In some implementations, the request for the single application page may include an identifier, such as an identifier for the client device and/or an identifier previously sent to the client device, such as a cookie. In other implementations, the request for the single application page may include authentication credentials (e.g., if the authentication credentials for the single application page are locally saved in a computer-readable storage medium of the client device and automatically transmitted with the request).

The web server may receive the request for the single application page and determine whether the client device transmitting the request is authenticated (block 204). In some instances, an identifier sent with the request may identify the client device as being authenticated. For example, an identifier stored as part of a cookie may identify the client device as previously authenticated.

If the web server determines that the client device is authenticated, then the single application page may be loaded along with any common application web resources and framework libraries (block 214). Once the single application page is loaded, the page may switch to a secured main view (block 216). In some implementations, the secured main view may be unhidden and the other views of the page (e.g., a login view and an error view) may be hidden. In addition, a request for resources for the main view of the single application page may be transmitted in response to the determination that the client device is authenticated, according to some implementations. In other instances, the content for the main view may simply be unhidden in response to the determination. An example main view for the authenticated and loaded single application page is shown in FIG. 5.

If the web server determines that the client device is not authenticated (at block 204), then the single application page may be loaded along with any common application web resources and framework libraries and switched to a login view (block 206) without loading a new application page. As noted above, the configuration for the single application page may use a form-based authentication having a login page set as the login view of the single application page using a first parameter and the error page set as the error view of the single application page using a second parameter and being essentially the same page as the protected resource being requested. The login view and error view may be identified via parameters “login” and “error,” respectively. Thus, the login view, error view, and protected main view are all part of the single application page and no separate login or error pages are needed. As the client device has been determined to not be authenticated yet, the login parameter may be used by the single application page to identify and load the login view after the single application page is loaded on the client device. An example login view for the single application page is shown in FIG. 3. In some implementations, the resources for the secured main view may also be loaded with the single application page, but may be hidden until the client device is authenticated. In other implementations, the single application page may be configured to load the resources for the secured main view only after the client device is authenticated. Thus, the secured main view may simply be an empty container that requests the resources only after authentication.

After the login view for the single application page is loaded, the user may cause the client device to send an authentication request to the web server (block 208). In one implementation, the user may enter login credentials (e.g., login name and password) into text entry fields and may submit the login credentials via the selection of a user interface, such as a button. In one implementation, when the user submits the login credentials an Ajax call to the function j_security_check may be used to determine whether the credentials entered by the user are authenticated. The Ajax call transmits the login credentials to the web server.

A determination may be made by the web server for whether the login credentials are accepted or not (block 210). The web server may be configured to respond to the determination by transmitting a URL for the single application page with no parameters (indicative of a successful authentication) or a URL for the single application page with an error parameter (indicative of an unsuccessful authentication) to the client device. In some instances, the web server may be configured to respond to the determination by transmitting a success parameter. If the login credentials are not accepted, then the web server may send a response with an error parameter, such as “error.” The single application page may receive the error parameter and switch to an error view (block 212) on the client device. When the single application page switches to the error view, it should be understood that the common application resources and framework libraries need not be loaded again. Rather, the single application page merely switches views on the client device, thereby reducing the data needed to be transferred and the processing by the web server to respond to the authentication. An example of the error view for the single application page is shown in FIG. 4. In some implementations, the error view may include text entry fields for a user to enter login credentials again and resubmit the login credentials as part of another authentication request (block 208). When the user submits the login credentials an Ajax call to the function j_security_check may be used again to determine whether the credentials entered by the user are authenticated. The Ajax call transmits the login credentials to the web server again. In some implementations, the single application page may remain in the login view and display error text rather than switching to an error view.

If the login credentials are accepted, then the web server may send a response with a URL for the single application page with no parameters (indicative of a successful authentication). The single application page then switches to the secured main view (block 216) on the client device without having to reload the application page. As will be appreciated, the common application resources and framework libraries are only loaded once on the client device when the single application page was initially loaded and the login view was presented. Thus, when the single application page switches to the main view, the common application resources and framework libraries need not be received from the web server again. Accordingly, the data to be transferred and the processing by the web server to respond to the authentication may be reduced.

When the single application page switches to the main view, in one implementation the data for the content to populate the main view may be retrieved from the web server only after the successful authentication. For example, a request for the resources for the content to populate the main view of the single application page from the web server may be transmitted only in response to the single application page switching to the main view. In some implementations, the files for the content of the main view of the single application page may be configured as secured resources on the web server such that the files are not loaded until after the client device is authenticated. In other implementations, the content of the main view of the single application page may simply be unhidden after authentication.

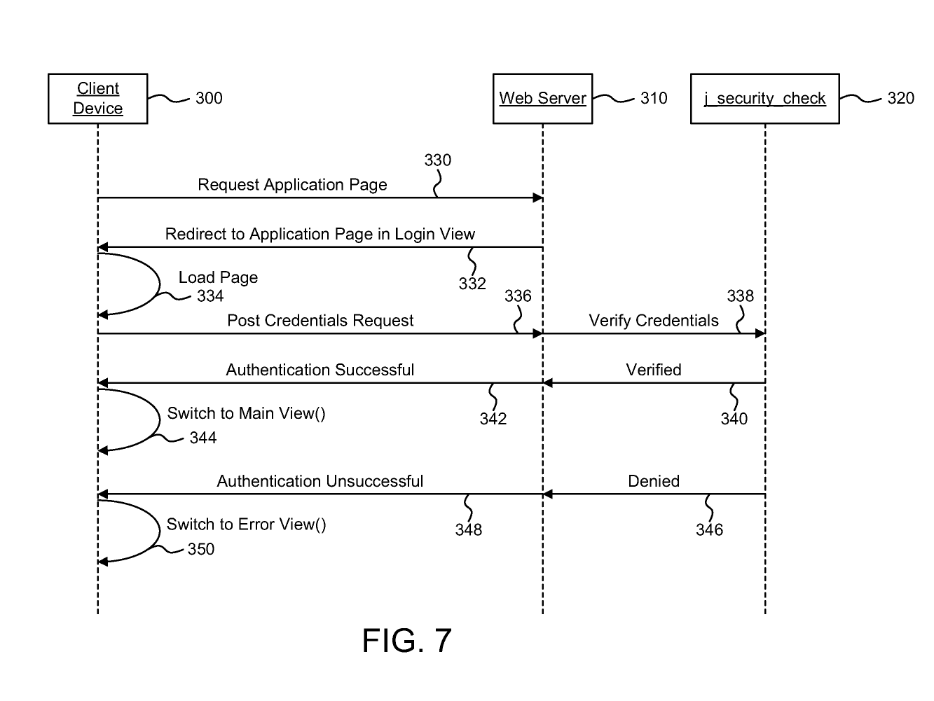

FIG. 7 depicts an example sequence diagram of a client device 300, a web server 310, and a j_security_check function 320. In some implementations, the j_security_check function 320 may implemented by the web server 310. In other implementations, the web server 310 may communicate with another computing device that performs the j_security_check function 320.

Initially the client device 300 may send a request 330 for the single application page, such as “app.jsp,” to the web server 310. As noted above, the request may include an identifier, such as an identifier for the client device and/or an identifier previously sent to the client device, such as a cookie. In other implementations, the request 330 for the single application page may include authentication credentials (e.g., if the authentication credentials for the single application page are locally saved in a computer-readable storage medium of the client device 300 and automatically transmitted with the request 330). The web server 310 may respond with the single application page along with any common application resources and framework libraries for the single application page. If the client device 300 was previously authenticated, such as may be indicated by an identifier sent with the request 330, then the web server 310 may also respond with an indication that the single application page is to be rendered in the main view.

If the client device 300 is not previously authenticated, then the web server 310 may respond to the request 330 by redirecting the client device 300 to the login view for the single application page 332 by returning a parameter “login” with the single application page. The web server 310 may respond with the single application page along with any common application resources and framework libraries for the single application page. The configuration for the single application page may use a form-based authentication having a login page set as the “app.jsp?login” view of the single application page based on the “login” parameter and the error page set as the “app.jsp?error” view of the single application page based on the “error” parameter and being essentially the same page as the protected resource being requested, but with the foregoing different URL parameters. When the single application page is initially loaded 334 by the client device 300, the parameterized login view may be loaded based on the return of the “login” parameter from the web server 310. Thus, when the single application page is loaded 334 by the client device 300, the page switches to the login view. The main view and/or error view may be hidden.

A user of the client device 300 may enter login credentials (e.g., login name and password) into text entry fields and may submit the login credentials via the selection of a user interface, such as a button. In one implementation, when the user submits the login credentials an Ajax call to the function j_security_check may be used to post the login credentials 336 to the web server 310. The web server 310 passes the login credentials 338 to the j_security_check function 330, which may be performed by the web server 310 or on another computing device.

If the login credentials are verified 340 by the j_security_check function 330, then the web server 310 may respond to the Ajax call with a URL for the single application page with no parameters, indicative of a successful authentication 342. When the client device 300 receives the URL, the single application page may be switched to the main view 344 by the client device 300. Thus, the single application page need not be reloaded, thereby reducing the data to be transferred and the processing by the web server.

If the login credentials are not verified 346 or denied by the j_security_check function 330, then the web server 310 may respond to the Ajax call with the URL for the single application page with an error parameter, such as “error,” indicating an unsuccessful authentication 348. When the client device 300 receives the error parameter, the single application page may be switched to the error view 350 by the client device 300. Thus, the single application page need not be reloaded, thereby reducing the data to be transferred and the processing by the web server. In some implementations, a user of the client device 300 may enter credentials again and re-post the credentials to the web server 310 from the error view.

As may be appreciated, existing web applications using a post-based approach for login authentication via a form-based user authentication mechanism may be adapted to utilize a single application page while still using previously implemented authentication mechanisms via the call to the authentication function. That is, the form-based authentication mechanism may be configured to have the designated login view and error view be essentially the same page as the protected resource being requested, but with different URL parameters. In addition, while JSP form-based authentication mechanisms have been described herein, it should be understood that other types of authentication mechanisms may be implemented using the foregoing processes.

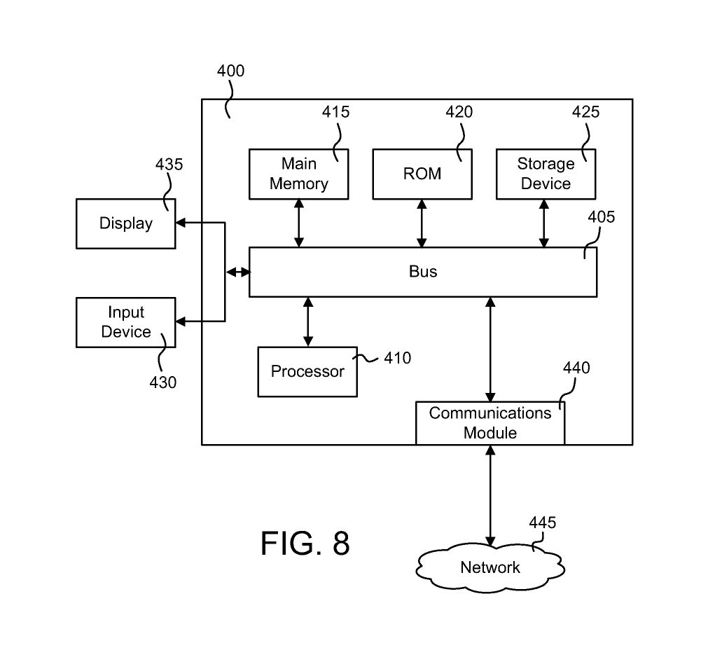

FIG. 8 is a block diagram of a computer system 400 that can be used to implement the client device 300, the web server 310, and/or any other computing device described herein. The computing system 400 includes a bus 405 or other communication component for communicating information and a processor 410 or processing module coupled to the bus 405 for processing information. The computing system 400 also includes main memory 415, such as a RAM or other dynamic storage device, coupled to the bus 405 for storing information, and instructions to be executed by the processor 410. Main memory 415 can also be used for storing position information, temporary variables, or other intermediate information during execution of instructions by the processor 410. The computing system 400 may further include a ROM 420 or other static storage device coupled to the bus 405 for storing static information and instructions for the processor 410. A storage device 425, such as a solid state device, magnetic disk or optical disk, is coupled to the bus 405 for persistently storing information and instructions. Computing device 400 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 400 may be coupled via the bus 405 to a display 435, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 430, such as a keyboard including alphanumeric and other keys, may be coupled to the bus 405 for communicating information and command selections to the processor 410. In another implementation, the input device 430 may be integrated with the display 435, such as in a touch screen display. The input device 430 can include a cursor control, such as a mouse, a trackball, or cursor direction keys, for communicating direction information and command selections to the processor 410 and for controlling cursor movement on the display 435.

According to various implementations, the processes and/or methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes and/or method steps described herein. One or more processors in a multi-processing arrangement may also be employed to execute the instructions contained in main memory 415. In alternative implementations, hard-wired circuitry may be used in place of or in combination with software instructions to effect illustrative implementations. Thus, implementations are not limited to any specific combination of hardware circuitry and software.

The computing system 400 also includes a communications module 440 that may be coupled to the bus 405 for providing a communication link between the system 400 and a network 445. As such, the communications module 440 enables the processor 410 to communicate, wired or wirelessly, with other electronic systems coupled to the network 445. For instance, the communications module 440 may be coupled to an Ethernet line that connects the system 400 to the Internet or another network 445. In other implementations, the communications module 440 may be coupled to an antenna (not shown) and provides functionality to transmit and receive information over a wireless communication interface with the network 445.

In various implementations, the communications module 440 may include one or more transceivers configured to perform data communications in accordance with one or more communications protocols such as, but not limited to, WLAN protocols (e.g., IEEE 802.11a/b/g/n/ac/ad, IEEE 802.16, IEEE 802.20, etc.), PAN protocols, Low-Rate Wireless PAN protocols (e.g., ZigBee, IEEE 802.15.4-2003), Infrared protocols, Bluetooth protocols, EMI protocols including passive or active RFID protocols, and/or the like.

The communications module 440 may include one or more transceivers configured to communicate using different types of protocols, communication ranges, operating power requirements, RF sub-bands, information types (e.g., voice or data), use scenarios, applications, and/or the like. In various implementations, the communications module 440 may comprise one or more transceivers configured to support communication with local devices using any number or combination of communication standards.

In various implementations, the communications module 440 can also exchange voice and data signals with devices using any number or combination of communication standards (e.g., GSM, CDMA, TDNM, WCDMA, OFDM, GPRS, EV-DO, WiFi, WiMAX, S02.xx, UWB, LTE, satellite, etc). The techniques described herein can be used for various wireless communication networks 445 such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. A CDMA network can implement a radio technology such as Universal Terrestrial Radio Access (UTRA), cdma2000, etc. UTRA includes Wideband-CDMA (W-CDMA) and Low Chip Rate (LCR). CDMA2000 covers IS-2000, IS-95, and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2).

Although an example computing system 400 has been described in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

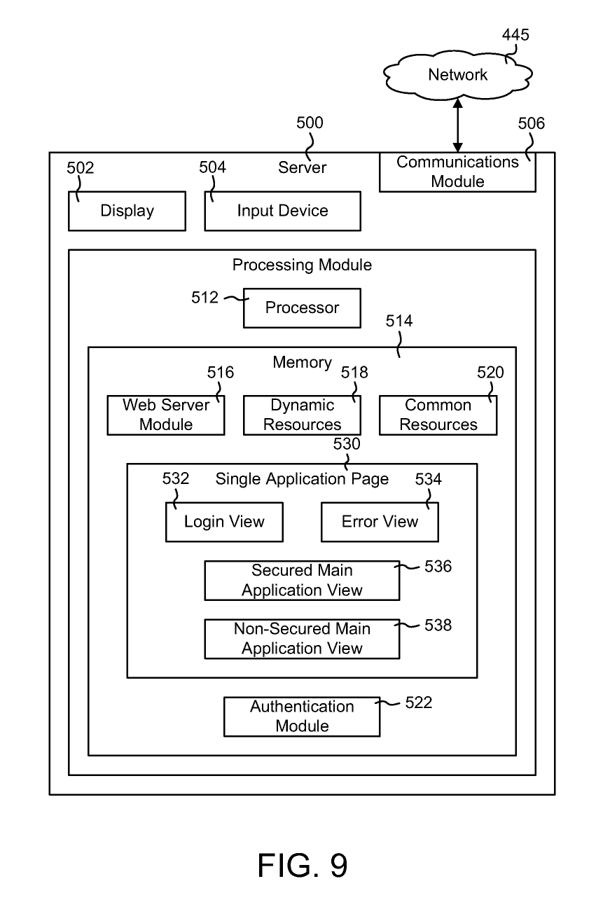

FIG. 9 is a block diagram of a web server 500 that can be used to implement the web server 310 of FIG. 7. The web server 500 includes a processing module that includes a processor 512 and a memory 514, such as a RAM, ROM, a solid state device, magnetic disk or optical disk, and/or any other memory device for storing information and instructions for the processor 512. The web server 500 may also include a display 502, an input device 504, and a communications module 506. The display 502, input device 504, and communications module 506 may be similar to the display 435, input device 430, and communications module 440 described herein.

The memory 514 of the present example may store a web server module 516, dynamic resources 518, common resources 520, an authentication module 522, and/or the single application page 530. In the present example, the web server module 516 may be configured to establish a connection with a client device via network 445 to transmit the data for the single application page 530. The dynamic resources 518 and the common resources 520 may include those resources that are to be transmitted to a client device with the single application page 530. For example, the common resources 520 may include images, text, etc. that are common to the different views of the single application page 530. The dynamic resources 518 may include images, text, etc. that are specific to each different view of the single application page 530. The authentication module 522 is a module configured to perform the j_security_check function described herein. The authentication module 522 may alternatively be configured to perform other authentication functions as well.

The single application page 530 may be configured similarly to the single application pages described herein. In the present example, the single application page 530 includes a login view 532, an error view 534, a secured main application view 536, and/or a non-secured main application view 538. The login view 532 may be configured in a similar manner to the login view shown and described in reference to FIG. 3. The error view 534 may be configured in a similar manner to the error view shown and described in reference to FIG. 4. The secured application view 536 may be configured in a similar manner to the main view shown and described in reference to FIG. 5. In some implementations, a non-secured main application view 538 may also be provided. The non-secured main application view 538 may be loaded prior to the login view 532 (e.g., the non-secured main view 538 may be loaded to show non-secure application portions and a selection feature, such as a login button, may be selected to switch to the login view 532). Of course, the non-secure main application view 538 may be omitted. When loaded and displayed by a client device, the single application page 530 may switch between the several views 532, 534, 536, 538 without having to load a separate login page and/or reload the main application page to authenticate a user.

Although an example web server 500 has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

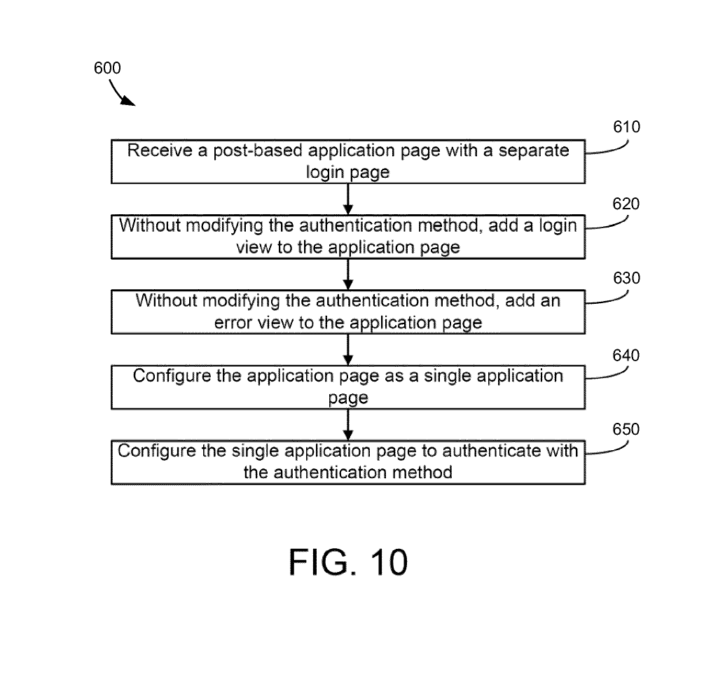

FIG. 10 depicts an example method 600 for configuring an existing post-based application page to a single application page with a login view and an error view. The method 600 includes receiving a post-based application page that has a separate login page (block 610). As discussed above, such a post-based application page and separate login page may request common resources multiple times when switching between the login page and the post-based application page. The method 600 includes adding a login view to the application page without modifying the authentication method (block 620). The modification to the application page may include adding a login view, such as that shown and described in reference to FIG. 3. Accordingly, the separate login page may be eliminated as the login view is integrated into the application page. In addition, the authentication method, such as using the function j_security_check, may still be used. Thus, the application page may be simplified while maintaining the existing authentication method. The method 600 includes adding an error view to the application page without modifying the authentication method (block 630). The modification to the application page may include adding an error view, such as that shown and described in reference to FIG. 4. The method further includes configuring the application page as a single application page (block 640). Configuring the application page as a single application page may include parameterizing the login view and error view and modifying the form-based authentication to reference the login view and error view instead of separate login and error pages. That is, the form-based authentication may be configured to have the designated login view and error view be essentially the same page as the protected resource being requested, but with different URL parameters. In addition, the method 600 still further includes configuring the single application page to authenticate with the authentication method (block 650). In the examples described herein, one such configuration may include adding an Ajax call to the function j_security_check for the authentication method. Of course other configurations may be utilized as well, and the foregoing is merely an example.

Implementations of the subject matter and the operations described in this specification can be implemented in digital electronic circuitry, or in computer software embodied on a non-transitory tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” or “processing circuit” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular embodiments. Certain features described in this specification in the context of separate embodiments can also be implemented in combination in a single implementation. Conversely, various features described in the context of a single implementation can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A method for authenticating login credentials for a single application page comprising:
requesting, using a client device, a single application page from a web server, wherein the single application page includes a main view, a login view, and an error view as part of the same single application page;
receiving, at the client device, the single application page from the web server;
loading, at the client device, the single application page in the login view;
transmitting, using the client device, login credentials to the web server; and
loading, at the client device, the single application page in the main view if the web server indicates that the login credentials are valid.

2. The method of claim 1 further comprising:
loading, at the client device, the single application page in the error view if the web server indicates that the login credentials are invalid.

3. The method of claim 2, wherein loading the single application page in the error view is performed in response to receiving a parameter associated with the error view.

4. The method of claim 1, wherein loading the single application page in the login view is performed in response to receiving a parameter associated with the login view.

5. The method of claim 1, wherein loading the single application page in the main view comprises requesting data for content from the web server to populate the main view if the web server indicates that the login credentials are valid.

6. The method of claim 5, wherein the data for the content is configured as a secured resource.

7. The method of claim 1, wherein loading the single application page in the main view comprises unhiding the main view.

8. The method of claim 1 further comprising:
loading, at the client device, the single application page in the login view if the web server indicates that the login credentials are invalid.

9. The method of claim 1, wherein the single application page uses a form-based authentication mechanism configured to have the login view and the error view as part of a same page as the main view, wherein the login view is associated with a first parameter and the error view is associated with a second parameter.

10. The method of claim 9, wherein transmitting login credentials to the web server comprises an Ajax call.

11. A system comprising:
a processing module; and
a non-transitory computer-readable storage device storing instructions that, when executed by the processing module, cause the processing module to perform operations comprising:
transmitting a JavaServer Page in response to a request from a client device,
receiving login credentials from the client device,
determining if the login credentials are valid, and
transmitting a URL for the JavaServer Page to the client device in response to the determination,
wherein the JavaServer Page is operable to switch to:
a login view if the client device is not previously authenticated,
an error view if the URL for the JavaServer Page is transmitted with a parameter indicating that the login credentials are invalid, and
a main view if the client device is previously authenticated or the URL for the JavaServer Page is transmitted without any parameters,
wherein the login view, error view, and main view are part of the same JavaServer Page.

12. The system of claim 11, wherein the login view and the error view are each associated with a corresponding parameter.

13. The system of claim 11, wherein the JavaServer Page is further operable to transmit the login credentials using an Ajax call.

14. The system of claim 11, wherein the instructions cause the processing module to perform operations further comprising:
transmitting a file for the main view only after the login credentials are determined to be valid.

15. The system of claim 14, wherein the file is configured as a secured resource.

16. The system of claim 14, wherein the JavaServer Page is further operable to unhide the main view if the client device is previously authenticated or the URL for the JavaServer Page is transmitted without any parameters.

17. The system of claim 14, wherein the JavaServer Page is operable to switch to the login view, the error view, or the main view without reloading resources.

18. A non-transitory computer-readable storage device storing instructions that, when executed by a processing module, cause the processing module to perform operations comprising:
transmitting a JavaServer Page in response to a request from a client device;
receiving login credentials from the client device; and
transmitting a URL for the JavaServer Page to the client device in response to the determination;
wherein the JavaServer Page is operable to switch between:
a login view, and
a main view,
wherein the login view and the main view are part of the same JavaServer Page;
wherein the JavaServer Page is further operable to transmit the login credentials using an Ajax call.

19. The non-transitory computer-readable storage device of claim 18, wherein the JavaServer Page is operable to switch to the login view if the client device is not previously authenticated and to the main view if the client device is previously authenticated.

20. The non-transitory computer-readable storage device of claim 18, wherein the instructions cause the processing module to perform operations further comprising:
determining if the login credentials are valid; and
transmitting a file associated with the main view only after the login credentials are determined to be valid.
